(19) United States
(12) Patent Application Publication
(10) Pub. No.: US 2006/0282271 A1
(43) Pub. Date: Dec. 14, 2006

(54) Method and apparatus for shipping mail and packages

(76) Inventors: Mohan Ananda, Westlake Village, CA (US); Steven J. Krause, Westlake Village, CA (US)

Correspondence Address: THE HECKER LAW GROUP, 1925 CENTURY PARK EAST, SUITE 2300, LOS ANGELES, CA, 90067, US

(21) Appl. No.: 11/150,662

(22) Filed: Jun. 10, 2005

(51) Int. Cl. G06Q 99/00

(52) U.S. Cl. 705/1

(57) ABSTRACT

A method and apparatus for facilitating shipping pick-up services and managing shipping information. A customer may register with a shipping information management system (SIMS) to provide customer preferences and billing information to enable transparent shipping services with the SIMS. When a customer purchases postage electronically, an application on the customer's computer detects postage printing activities and extracts shipping information. The extracted shipping information is transmitted to a SIMS server, from which pick-up instructions are automatically issued to a pick-up service provider. Payment for the pick-up service may be verified at the time the pick-up instruction is issued. The SIMS apparatus may also provide tracking status to customers, as well as shipping information data-mining services to shipping service providers.

### FIELD OF THE INVENTION

The invention relates to the field of electronic systems for facilitating mailing and shipping.

A portion of the disclosure of this patent document contains material which is subject to copyright protection. The copyright owner has no objection to the facsimile reproduction by anyone of the patent document or the patent disclosure, as it appears in the Patent and Trademark Office file or records, but otherwise reserves all copyrights associated with this document.

### BACKGROUND

The shipping of mail and parcel items can typically be described in terms of three primary transport legs. In the first leg, sometimes referred to as “the first mile,” a shipping item (e.g., an envelope, a package, etc.) is taken from an initial sender's address to a local collection center of a shipping service provider. In the second leg, the item is transported from the local collection center to a delivery center. In the third leg, sometimes referred to as “the last mile,” the item is transported from the delivery center to its final destination address.

It is possible that multiple shipping service providers may be used over the three primary transport legs set forth above. For example, a local courier might provide transportation of a package from a business to a national or regional carrier's drop location, thus handling the first leg. The national or regional carrier might then provide service over the second leg, transporting the package from the drop location, possibly through one or more intermediate hubs, to a delivery center near the destination address. A third shipping entity, such as the United States Postal Service (USPS) may then provide delivery over the last leg.

It is also possible that a single shipping service provider may provide service over two or more legs. For example, a local courier might provide service over the first leg by transporting a package from a business (or residence) to a local post office, where the USPS provides service over the second and third legs. For local or regional deliveries, some shipping entities may even provide door to door service on their own.

The United States Postal Service (USPS) has a long history of providing mailing services. The USPS and some other shipping service providers, such as United Parcel Service (UPS) and Federal Express (FedEx), have an established infrastructure for carrying out the second and third legs of the shipping process. These companies are well equipped for sorting, routing and transporting mail and parcel items once the items are received at a collection warehouse.

The first leg, however, requires that the sender either bring the items (i.e., the shipment) to the collection center or make arrangements for a shipping service provider (e.g., a local courier) to pick up the item from the initial address. For example, until recently, in order to use the shipping services of the USPS, one had to either wait for the postman to come on his regularly scheduled delivery rounds, or carry the shipment to the post office and wait in line to hand the shipment to the USPS. To address this issue, some shipping service providers have specialized in picking up shipments from customers and transporting them to the addressee's local post office. Shipping service providers such as UPS and FedEx provide shipment pick-up from the sender's premises.

In addition to providing pick-up services, shipping service providers are looking to new technology to improve consumer access to shipping services. Specifically, in the case of the USPS, customers are able to print postage over the Internet using their own computers and printers, including through third party postage vendors such as Stamps.com™. Such postage can be used for mailing and shipping. The USPS has also introduced Click-N-Ship, a service by which customers can print shipping labels that include the postage value for certain classes of shipments. A similar service is available to customers of eBay™. In both of these cases, the customer may also navigate to a Web page to request limited pick-up services.

The pick-up process, as it is currently conducted, is cumbersome and costly to the customer and the shipper. Unless there are large numbers of packages to be collected from each pick-up point, the cost of picking up shipments from a single customer is relatively high for a shipping service provider. Also, for a service provider to optimize its pick-up stops, the customer has to follow scheduling restrictions. For example, in order to use the USPS pick-up services, the customer has to schedule a pick-up time through the USPS web site over the Internet for each pick-up. This solution is only convenient for the occasional customer. For customers that ship more frequently, such a scheduling mechanism is inefficient.

These solutions for helping customers ship mail and parcels still put a burden on the customer, e.g., by necessitating time-consuming customer interaction, creating time restrictions and/or demanding higher costs. Therefore, there is a need for an efficient solution to facilitate the process of shipping for the customer.

Also, where the customer uses one shipping service provider for the first leg (i.e., pick-up) and one or more additional shipping service providers for subsequent transport legs, each shipping service provider is unaware of the shipment while it is in the custody of another provider. Even where a customer has purchased postage online, the shipping service provider from which the postage was purchased cannot account for the shipment in its shipping plans until such time as the shipment is placed in their custody and the postage label is scanned into the shipping service provider's system. Thus, shipping service providers are unable to accurately predict transportation and handling needs, and as a result, resources are not optimally allocated for efficiency and economy. It would be desirable to have a centralized shipping information source through which multiple shipping service providers might obtain information about shipping schedules for preceding transport legs.

Another drawback of current shipping schemes is the manner in which customers select and schedule pick-ups for the first transportation leg. If the customer chooses to arrange for a pick-up through a large shipping service provider, there is no guarantee for the customer that the pick-up is being performed by the most cost-effective means. Larger shipping service providers are less likely to know about or take advantage of less costly local pick-up options (e.g., independent messenger/courier services) in every city or neighborhood. Further, even if the large shipping service provider subcontracts pick-up services to a less-expensive local shipping service provider, any savings may not be passed on to the customer (e.g., due to flat fee pick-up charges established at the regional, rather than local level).

To access less expensive pick-up options, a customer would have to investigate the pick-up service providers available, and then make alternate arrangements directly with those providers. Further, where the nature of the shipment entails special handling, the customer must perform his or her own research to locate a shipping service provider with pick-up services satisfying those special handling needs, or the customer must entrust such decisions to the larger service provider, likely for greater cost than necessary.

As an added drawback to the above scenario, many local shipping service providers, as independents, rely on established contracts with businesses having sufficiently large and consistent shipping volume to support their business. Despite the fact that local shipping service providers may have additional space available in their vehicles, pick-up service for individual shipping transactions may prove too unprofitable to support, at least without charging a higher shipping fee. Such circumstances discourage the use of otherwise viable shipping options for smaller businesses, individuals, or businesses with less consistent or voluminous shipping needs. It would be desirable to have a system that could capture such shipping transactions across a population and coordinate with local shipping service providers to present a viable pick-up service solution involving independent and/or local shipping service providers.

### SUMMARY OF THE INVENTION

The present invention is a method and apparatus for facilitating shipping. One or more embodiments of the invention provide coordination of multiple shipping service providers and assist the customer in multiple shipping tasks, such as ordering and scheduling shipping and pick-up services, obtaining shipping status and managing information for the entire shipping process. Moreover, the system may automatically execute many of these tasks.

One or more embodiments of the invention may include a network-based shipping information management system (SIMS) that is accessible to a customer, e.g., on the world wide web (WWW). Components of the system may reside in a server that customers are able to access remotely using, for example, web browser software such as Internet Explorer or Netscape Navigator. Embodiments may also include a client application that executes on the customer's computer. The client application may execute as a separate process, or as a helper application that extends a web browser's capabilities and enables the latter to communicate with an embodiment of the invention. The client application may, for example, use active-x controls or a thin-client module (e.g., a JAVA applet) that may be downloaded to the customer computer at the time of customer registration. In one embodiment, the client application collects certain data related to shipping transactions from the customer's computer, and detects such transactions when the customer generates shipping related labels. The client application may also be designed to execute when the customer attempts to reach a web site that provides label printing capabilities.

The customer may register with a system embodying the invention to provide information such as the customer's address, customer billing information (e.g., credit card information), and customer shipping preferences. Subsequent to registration, the customer may access the system using authentication methods (e.g., user identification and password parameters), e.g., to update billing information, change preferences, etc.

One or more embodiments of the invention work with (and in support of) third party shipping and mailing software tools. For example, the client application may be automatically activated when the customer prints a shipping label through a web site or other postage interface of a shipping service provider or third party postage vendor. As part of the label printing process, the customer provides transaction-specific information about the shipment, such as the selected class of shipping, the destination address, the weight and/or size of the package(s), etc. Further transaction-specific information (e.g., value, corrected address, shipping identifier, etc.) may be derived by the postage provider based on the customer's information. This transaction specific information may then be presented on the printed label. In one or more embodiments, the client application may intercept this information when the label is printed, and transmit the transaction information to the SIMS server. The SIMS server uses the shipment transaction information and the customer's preferences, source address and billing information to verify payment, select a pick-up service provider and schedule pick-up of the package.

The system may provide the pickup service provider with the customer identification, shipment related information including the current location of the shipment, the identification of the shipping service (e.g., the USPS), and mode of shipment (e.g., priority, express, global express, parcel post, or parcel select or any other type of air, ground or sea mode of shipment).

Pick-up instructions may be communicated to a pick-up service provider in a variety of communication formats (e.g., as email, an instant message, a voicemail message, or a proprietary communication format. The SIMS server may be used to automatically generate and dispatch instructions directly or indirectly (e.g., through a courier dispatcher) to the drivers of a pick-up service provider. In one or more embodiments, the customer specifies a preferred pick-up service provider in the customer's preferences, though the SIMS server may also identify the cheapest or most appropriate service provider (e.g., to meet certain requirements of a particular shipment) available at the time the request is issued. In one embodiment, the pick-up service provider responds at a pre-assigned pick-up time (or one of several pre-assigned pick-up times) on the day the pick-up instruction is generated.

A system embodying the invention may optimize selection of the assigned courier and/or individual person based on a number of shipping parameters. For example, based on the location of a given driver at a given time, the system may minimize the driver's travel distance, and hence the pick-up delay, by selecting the driver closest to the pick-up location.

With shipping service providers such as the USPS, the pick-up service provider may deliver the shipment ed to the nearest post office or shipping service provider office. In the case of other shipping service providers, the shipments may be collected from the pick-up courier's warehouse by the second leg's shipping service provider.

An embodiment of invention may also be configured to generate shipping labels for certain additional modes of shipment that can be printed online by the customer. The printing of such a label would automatically initiate a pick-up notice for the associated shipment.

Embodiments of the invention may collect service fees by conducting payment transactions using credit cards, debit cards, or any other available payment method. In one or more embodiments, payment for the pick-up service is verified through a customer's billing account prior to transmission of the pick-up instruction to a pick-up service provider. In the event that a payment transaction fails, user alerts (e.g., pop-up windows) may be used to provide the customer with an opportunity to select an alternate payment account or to update the existing account.

Once the pick-up instruction has been transmitted, a confirmation of the scheduled pick-up may be transmitted automatically to the customer (e.g., as an email). In the event that a customer has disabled the automatic scheduling of pick-up services, detection of label printing may trigger a user prompt, giving the customer the opportunity to resume automatic pick-up scheduling for the current shipment only or for all future shipments.

In one or more embodiments, following a shipping order, a customer may track the shipment and delivery status centrally using the SIMS server, regardless of which shipping service the customer has used. The customer may also have access to a summary report of all the shipping and payment activities that is stored, for example, in the database of the SIMS server.

### BRIEF DESCRIPTION OF THE DRAWINGS

FIG. 1 is a Use Case diagram illustrating a system for managing shipping transactions and information in accordance with an embodiment of the invention.

FIG. 2 is a flowchart illustrating a process for ordering shipping and pickup using a SIMS system in accordance with an embodiment of the invention.

FIG. 3 is a flowchart that depicts a customer registration process in accordance with an embodiment of the invention.

FIG. 4 is a flowchart depicting a shipping and pickup transaction in accordance with an embodiment of the invention.

FIG. 5 is a flowchart depicting a process for collecting shipping information and managing collection order in accordance with an embodiment of the invention.

FIG. 6 is a block diagram that represents the layout of a distributed system architecture implemented in an embodiment of the invention.

FIG. 7A is a block diagram that represents the layout of a server in an embodiment of the invention.

FIG. 7B is a block diagram of modules contained in a shipping management module in an embodiment of the invention.

### DETAILED DESCRIPTION

A method and system for facilitating shipping of mail and packages are described. In the following description, numerous specific details are set forth to provide a more thorough description of the invention. It will be apparent, however, to one skilled in the art, that the invention may be practiced without these specific details. In other instances, well known features have not been described in detail so as not to obscure the invention. The claims following this description are what define the metes and bounds of the invention.

One or more embodiments of the invention allow a user to conveniently ship mail and/or goods using any available shipping service provider (e.g., the USPS). A system embodying the invention may comprise server tools for purchasing postage or connecting to third party postage vendors, ordering pick-up of a shipment and managing information over the course of the shipping process. Compared to prior solutions, embodiments of the invention provide a convenient, efficient, reliable, cost effective and less administratively cumbersome manner to ship mail and goods.

The invention described herein is set forth in terms of methods and systems implementing those methods. It will be apparent, however, to one with ordinary skill in the art that the invention may be implemented as computer software, e.g., computer program code capable of being stored in computer memory and executed by a microprocessor.

Terminology

In the following description, shipping refers to the transport of any mail or goods using any available transportation means. Shipping typically involves one or more legs of transportation from an origin location to a destination. Terms referring to mail, package, parcel or shipment are interchangeably used to refer to any and all shipped items.

The disclosure may interchangeably refer to a courier, a pick-up service provider and a shipment collector as a person, a group of persons or a company that carries out the task of transporting a shipment from an initial location (e.g., a customer's business location or residence) to a different location.

The term “user” in the disclosure, may refer to a person using a computer application and/or to one or more processes interacting with a computer application or system. A process may be any computer program executing locally or remotely, and which may be triggered by one or more events. An event is defined as the occurrence of a low-level action (e.g., establishing a network connection or opening a file), a high-level action (e.g., receiving registration data from a user), or a combination of actions (e.g., receiving a postage file for printing or issuing a print instruction in order to send postage to a printer).

A “server” may refer to a machine acting as a server, or to an application running on the machine to provide a service (e.g., a web server). Furthermore, a machine server may comprise one machine or a cluster thereof configured to provide one or more services. Conversely, a single machine (or cluster thereof), may be configured to execute a plurality of programs providing more than one service.

References to a “data source” in the disclosure refer to any type of means that allow a computer to obtain data using one or more protocols. A data source may be a flat file residing on a file system (e.g., magnetic/optical storage drive), an electronic mail server, a Lightweight Access Directory Protocol (LDAP)-based server or any other type of means capable of providing or serving data. In addition, references to a database may refer to a data source as defined above, and to a relational database as conventionally defined in the art of computer programming. A database may include, for example, multiple tables containing multiple records. A database may have a data storage schema (e.g., star schema) that describes the structure/organization of data in the relational database. A database may also be implemented using any other type of database structure.

One or more embodiments of the invention are described below as a computer program or programs based on a modularized architecture. Each component or module may be implemented as part of a larger infrastructure (e.g., within an application server) or as one or more plug-in programs, applets, dynamically loaded libraries, or any other configuration that allows programs to run on one or more computers in order to provide shipping information management. The programs may be embedded within, or interfaced with third party applications. Although described in modular terms for purposes of illustration, embodiments of the invention need not be limited to modular implementations. The functionality described herein may be implemented in software (and/or hardware) as a single process or as a combination of multiple processes and/or applications.

The following description also references encryption methods, which may include any available encryption method that may be adapted for use at any level within an embodiment of the invention to provide data security for storage and access control (e.g., authentication). Examples of known encryption methods include Data Encryption Standard (DES) and Rivest Shamir Adleman (RSA).

Overview: Shipping Information Management System (SIMS)

One or more embodiments of the invention may include a shipping information management system (SIMS). Shipping typically involves multiple coordinated tasks associated with transporting and tracking a shipment from a source location to a destination. Such tasks may include, for example, buying postage, choosing a shipper, ordering pick-up, and tracking the shipment to its final destination. The SIMS system provides the customer with access to any of those tasks, and manages shipping transactions. For example, a customer may utilize the system to select a shipper, access a postage vendor, and order pick-up of a shipment. Alternatively, the customer may interact with third party systems (e.g., for purchasing postage or ordering shipping), in which case the SIMS system may obtain the shipping order information, and transparently coordinate other shipping procedures (e.g., pick-up).

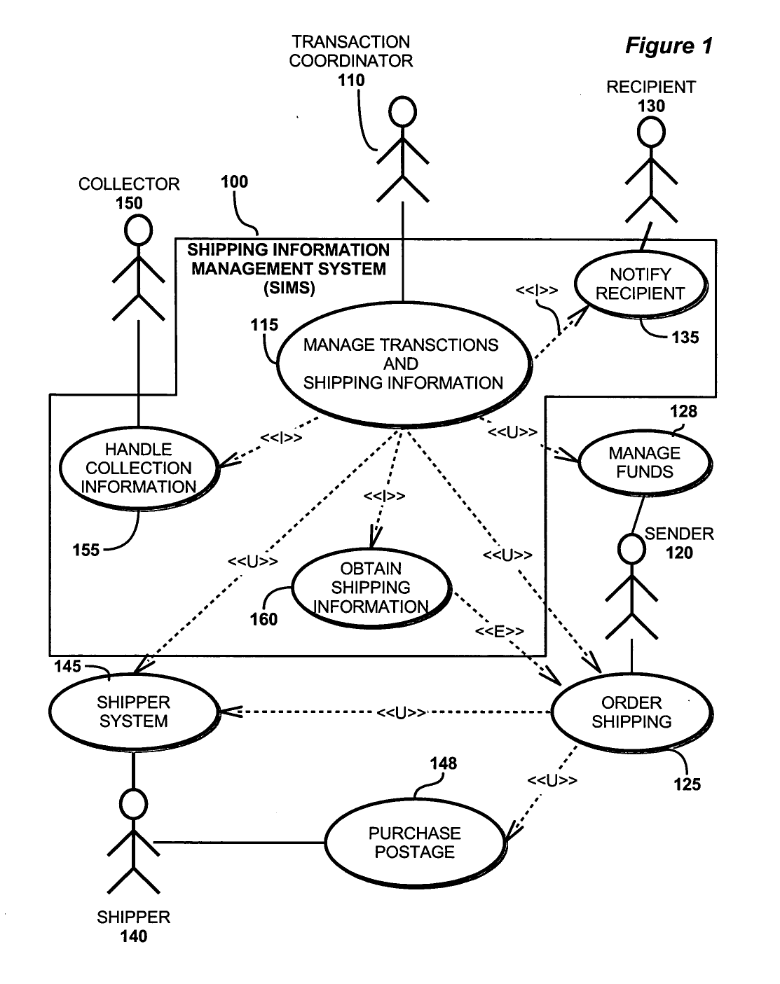

FIG. 1 is a Use Case diagram illustrating the system for managing shipping transactions and information in accordance with an embodiment of the invention. FIG. 1 shows actors, actions and relationships using standard notations of the Unified Modeling language. FIG. 1 also shows labels that indicate the relationship between functional modules in accordance with one or more embodiments of the invention. Labels “<<I>>”, “<<U>>” and “<<E>>” indicate “include”, “uses” and “extend” relationship types, respectively. Within SIMS, the relationship between functional modules may be one of several types. A functional module may include one or more other functional modules (e.g. functional module 115 representing the functionality for managing information and conducting shipping transactions includes functional modules 135,155 and 160 representing the functionalities for handling shipment pickup information, managing user notifications and gathering shipping information, respectively). A functional module may use other functional modules (e.g. functional module 125 uses functional module 145). Also, a functional module may extend the capabilities of other modules (e.g., functional module 160, which may represent a helper application, extends functional module 125 which may represent an web browser).

As shown in FIG. 1, SIMS (block 100) may include functionality that allows several parties involved in shipping to communicate, conduct business transactions and manage shipping information. A sender, represented by actor 120, may use a client system, represented by block 125, to communicate with SIMS's server functionality. Client system 125 may include, for example, applications executing on a personal computer equipped with a web browser.

Client system 125 may communicate directly with the remote functionality of SIMS, represented by block 115, or client system 125 may utilize a proxy application, represented by block 160. Proxy application 160 may be installed on a user's client system to communicate with other parts of SIMS 115, detect and obtain shipping information from a local system, and provide transparent and automatic execution of procedures related to shipping. For example, a sender 120 may connect directly with a shipping company's services (e.g., block 145) or a third party postage vendor's services (e.g., block 148) to order shipping. The proxy program 160 may obtain shipping information and convey it to SIMS 115, which may in turn automatically order pick-up, select and notify a particular courier (represented by actor 150), and notify a recipient (represented by actor 130).

An embodiment of SIMS 115 may include multiple data management modules that allow the system to securely store information, securely and transparently communicate with client systems, and generate communication messages. For example, SIMS 115 may include modules that allow the system to communicate directly with a collector (i.e., a pick-up service provider or an individual driver for such a service provider). SIMS 115 may include a module, such as block 155, that selects a type of communication means (e.g., telephone or text messaging), and generates the appropriate message (e.g., voice mail, text message) for a given collector. Similarly, SIMS 115 may include modules, such as functional block 135, to communicate with recipients at the package destination.

SIMS 115 may implement one or more financial transaction interfaces to communicate with third party financial institutions (block 128) to transfer funds (e.g., for collecting payment), receive electronic transfer funds and conduct any other required financial transactions.

In addition, SIMS 100 may provide intelligent tools that perform data-mining of the cumulative shipping data in order to optimize the shipping process. Based on the collected shipping information, the SIMS system may determine one or more attributes, such as weight, type of shipment and other attributes in order to issue a recommendation to the collector, or to use in the selection of a most appropriate collector from a set of available collectors. For example, the shipment may consist of a live animal needing a special carrier, an oversized box needing a weight lifting device, a chemical needing special hazard protection, a food item needing refrigeration, etc.

In one or more embodiments of the invention, one or more computer program extensions may be implemented in third party systems (e.g., 145), to trigger events in SIMS based on the user's actions and/or shipment status. For example, a transaction coordinator (e.g., actor 110), may provide a contractual service to a shipper (e.g., USPS), where both parties agree to implement the program extension of SIMS in the shipper's system (e.g., block 145), to allow the latter system to interact with SIMS.

Managing Shipping Transactions Through SIMS

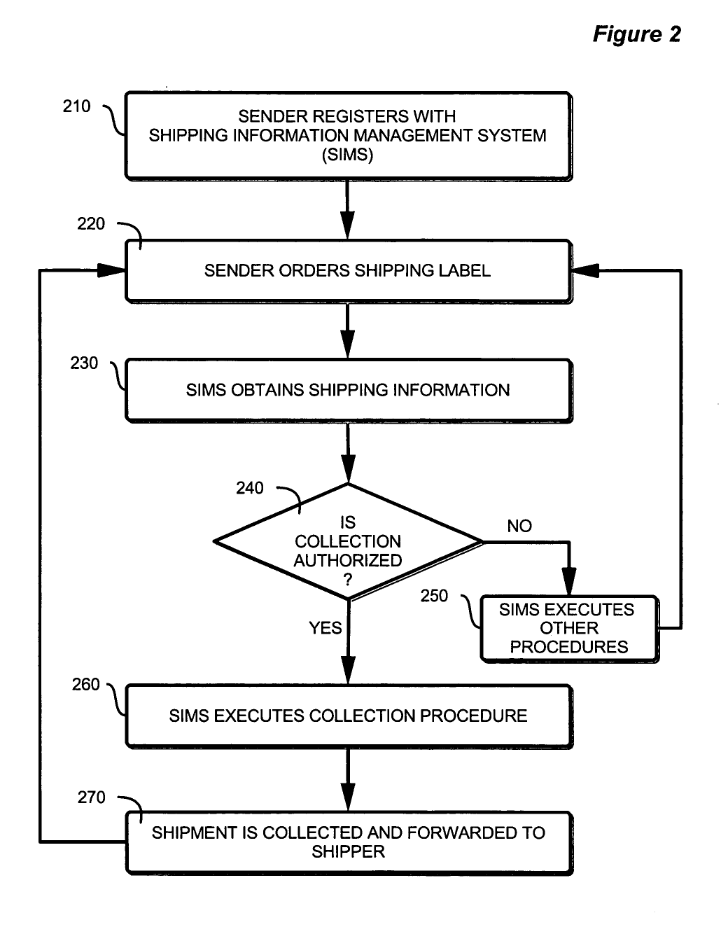

FIG. 2 is a flowchart illustrating a process for ordering shipping and pick-up using SIMS in accordance with one or more embodiments of the invention. At step 210, a customer registers with SIMS. The registration stage allows SIMS to capture the customer's personal information, payment methods, and the user's preferences for using the system. The registration process may involve obtaining a software application, and installing and configuring the application.

While registering with SIMS, the customer may provide preferences for routine procedures SIMS may follow when the customer takes specific actions. For example, the customer may indicate whether SIMS may automatically draw funds from the customer's bank account, in the event that the balance of funds is insufficient to cover the cost of a service. The customer may indicate whether SIMS has standing authorization to automatically schedule a pick-up (and charge the customer's account) when a shipping order has been placed. The customer may select confirmation options (e.g., whether to send pick-up confirmation messages to the customer for each scheduled pick-up, and how and where the confirmation messages should be transmitted). The customer may also indicate preferences for one or more pick-up parameters. For example, the customer may indicate one or more preferred pick-up service providers, one or more preferred standard pick-up times (e.g., same evening or next morning), etc. The customer may also select additional options beyond those specific to pick-up services. For example, the customer may indicate whether the system should automatically send a notification message (e.g., by automatic voice-message or email) to the intended recipient, or automatically send tracking status to the customer while the package is being shipped. Embodiments of the invention may provide any customization related to any service at registration time or at any later time either automatically or per request from a customer or SIMS administrator.

At step 220, the customer orders shipping. Ordering shipping may involve connecting to SIMS and choosing from a menu of shippers, then connecting to a selected shipper's system to order shipping. SIMS may provide information about shippers in a variety of ways. SIMS may present information about different shippers, such as regional availability, speed of delivery, customer satisfaction feedback and any other information SIMS may be capable of mining and providing to the customer.

Alternatively, a shipping order may be initiated by the customer through a shipper's interface or a third party postage vendor's interface, without the customer expressly contacting the SIMS system. In this situation, an application on the customer's computer detects the shipping order transaction (e.g., by intercepting a postage label printing command), and automatically sends the necessary information to the SIMS system.

Current methods for electronically ordering shipping typically include generating a purchase receipt and/or a postage label. The label is printed on a local printer and affixed to the shipment. The label typically contains shipping information, such as the source and destination addresses, the size and/or weight of the package, and the shipper for the second (and possibly third) transport leg.

Step 230 represents the process by which SIMS collects shipping information. In one embodiment of the invention, a proxy application such as that described above (in block 160) may access the label information being printed, collect the relevant shipping information, and then send that information to SIMS servers. In another embodiment of the invention, the shipper's system may automatically notify SIMS of the transaction, for example, by transmitting the shipping information directly to the SIMS servers or by transmitting the shipping information to the SIMS helper application executing on the customer's computer.

At step 240, the SIMS system checks the user's preferences to determine the procedures to follow in order to complete the shipping. In one case, the SIMS system may determine that the user did not authorize pick-up. In the latter case the system may execute a given procedure, as in step 250. For example, the system may generate an email to notify the sender that a shipping transaction was ordered, but that no pickup was scheduled. Such an email may include a web link or other mechanism for the customer to authorize scheduling of a pick-up (e.g., one-time authorization or continuous authorization). The system may also generate a notification to the intended recipient.

If the SIMS system determines that pick-up is authorized at step 240, then the system executes a shipment collection procedure. The latter procedure may involve analyzing the shipping information, determining any specific collection requirements, selecting a collector, selecting a mechanism for communicating with the collector (e.g., email, instant message, etc.), determining the availability of the collector, transmitting the collection instructions to the collector, confirming the collection schedule, and informing the sender about the pick-up schedule.

At step 270, the collector executes the first stage of the shipping process, e.g., by picking up the shipment and carrying the shipment from its source location to the shipper's collection warehouse. SIMS may be configured to collect shipping status of a shipment and notify and/or make available the shipping status to customers.

Embodiment of a Customer Registration Process

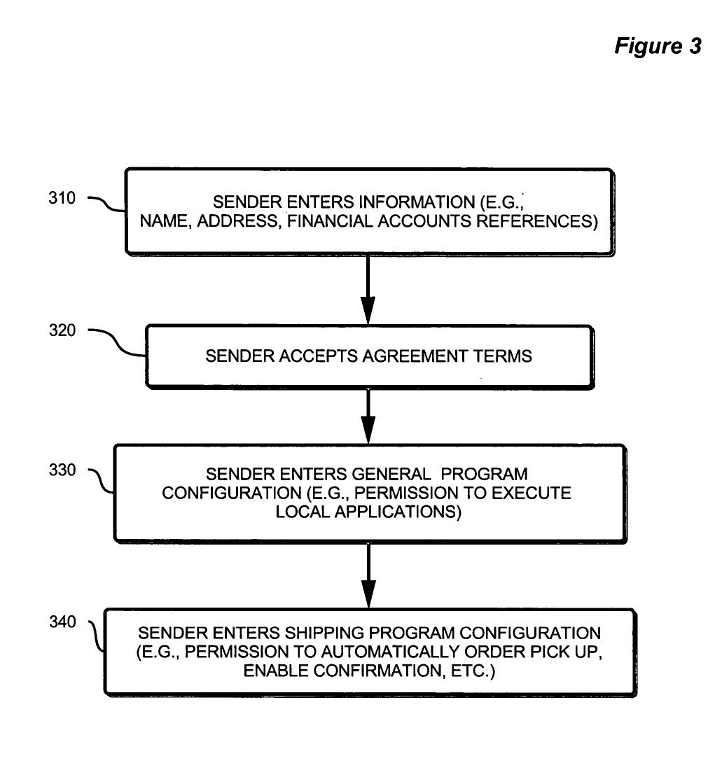

FIG. 3 is a flowchart of a customer registration process in accordance with an embodiment of the invention. To start using the system, a user may begin by connecting to a download server to obtain a client application. The client application may comprise a stand-alone application, a service process (also known as a daemon process) capable of running in the background along with the operating system, and/or a plug-in that is capable of executing with other applications (e.g., a web browser) to implement SIMS functionality.

At step 310, the user (e.g., Sender) enters personal information to identify and authenticate the user as well as to certify communications with the user. The personal information may include, name, address, financial institutions information and any other information that may be used by the system to facilitate shipping and/or improve security.

Once the data is securely transmitted to SIMS, SIMS may analyze the data for any potential errors, and validate the data. For example, SIMS may establish a link with the designated financial institution to verify the accuracy of the personal information, and validate the user's entries.

Upon validation of the user's information, SIMS may present a user agreement comprising a set of terms and rules (statutory and/or contractual) that the user must acknowledge and accept in order to activate service. At step 320, the user reviews the agreement and provides an input that indicates the user's consent to the terms.

At step 330, the user configures the local application. Because of security issues related to executing service applications in modern computer operating systems, the installation process may entail user input to authorize/enable installation and execution of the local application on the user's computer. In one embodiment, the application may be configured with permissions to read and write to system files and communicate with other parts of the system. Such permissions would permit, for example, a proxy application to obtain a copy of a print job to obtain information from a shipping label, e.g., by accessing the printing modules of the user's computer.

Alternatively, the installation of the application may be automatic. In the latter case, the user indicates to the installation program to proceed with all the steps necessary to set all the permissions and access credentials to the local system and third party systems. For example the installation process may register with a local firewall, anti-virus applications and any other security software that may be involved in controlling the system's data flow.

At step 340, the user inputs SIMS service configuration data. SIMS may request input from the user to determine the behavior of each service provided by SIMS in accordance with the user's preferences. Depending on the services and type of each service the user may have requested, SIMS may generate appropriate GUI (graphical user interface) windows to walk the user through the configuration process. For example, if the user chooses to authorize a pick-up service, SIMS may request that the user indicate any pick-up time constraints (e.g., for perishable or time-sensitive shipments), and any other uniform requirements for handling shipments (e.g., extra care for a glassware business's typical fragile shipments).

Embodiment of Shipping Order Process

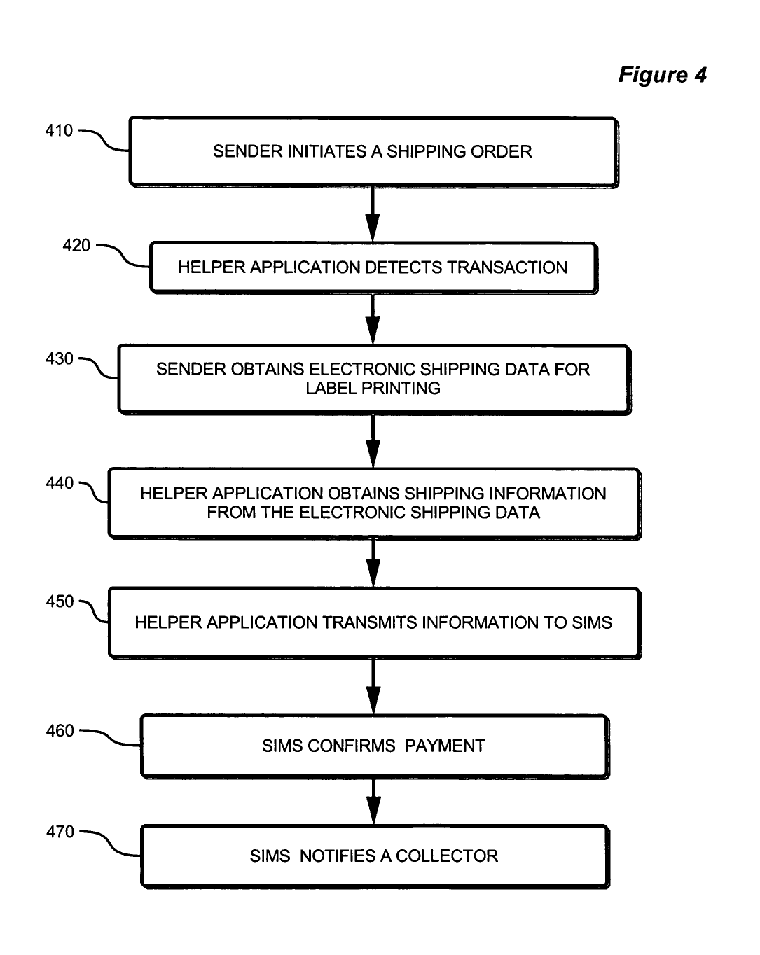

FIG. 4 is a flowchart of a shipping and pick-up ordering transaction in accordance with an embodiment of the invention. At step 410, a customer initiates a shipping order. Typically, the user connects to a shipping provider (e.g., USPS, UPS or FedEx) or to a third party postage vendor to purchase postage. The system embodying the present invention allows a customer access to information that may not be available otherwise. For example, the system may search for special promotions the user may be interested in using or trying, e.g., as determined from the customer's shipping habits. In other instances, the system may present alternative ways of shipping that may optimize the time and/or the cost of shipping. Or, the system may provide a comparative list of possible shipping service providers to help the customer make a selection.

In one or more embodiments of the invention, the client application (which is also referred to herein as the proxy application) detects a shipping order transaction, at step 420. The proxy application may be configured to analyze network connections to determine whether the user is about to order shipping. For example, the application may analyze certain HyperText Transport Protocol (HTTP) requests, exchanged between a web browser and a pre-determined website (e.g., <USPS.com>) to determine whether a user has placed a shipping order.

Typically, the shipping order is complete when the customer has obtained the proper shipping label. At step 430, the user obtains the shipping document. For example, the customer may obtain a shipping label upon completing a postage purchase transaction. The label typically contains multiple items of information, such as source and destination addresses, weight and any other information on the shipping label and/or on an electronic receipt.

In one embodiment of the invention, the proxy application collects such information from the shipping label, at step 440. However, other embodiments of the invention may utilize one or more different ways for obtaining shipping information. For example, the shipper's system may be configured to automatically transmit the data to SIMS. In other instances, SIMS may act as a broker for purchasing postage, in which case SIMS would also generate the shipping label and confirmation data.

At step 450, the proxy application transmits the collected shipping information to the SIMS server. The proxy application may invoke one or more procedures, depending on the user's preferences, to communicate with a user. The proxy application may, for instance, display a confirmation message in order to notify the user that shipping information has been collected and that the information is being sent to the SIMS server in order to proceed with scheduling a pick-up. The proxy application may request the user's input to validate such request.

At step 460, SIMS receives the shipping order information and proceeds to schedule a pick-up. Based on the collected shipping information, SIMS may compute the total cost for pick-up, check whether funds are available to cover the cost of pick-up, and execute a funds transfer transaction.

If SIMS determines that a pickup is to be scheduled, SIMS selects a courier (i.e., local pick-up service provider) to pick up the shipment and carry it to the selected shipper. SIMS may automatically select a means (e.g., telephone voice message or text messaging) for communicating with the courier, and transmit the information directly to the courier. For example, the SIMS server may notify the courier about the type of goods contained in the shipment, and issue a recommendation for pick-up. An example of such recommendation would be to bring sufficient help to carry a shipment, if the weight is too large for one person to handle.

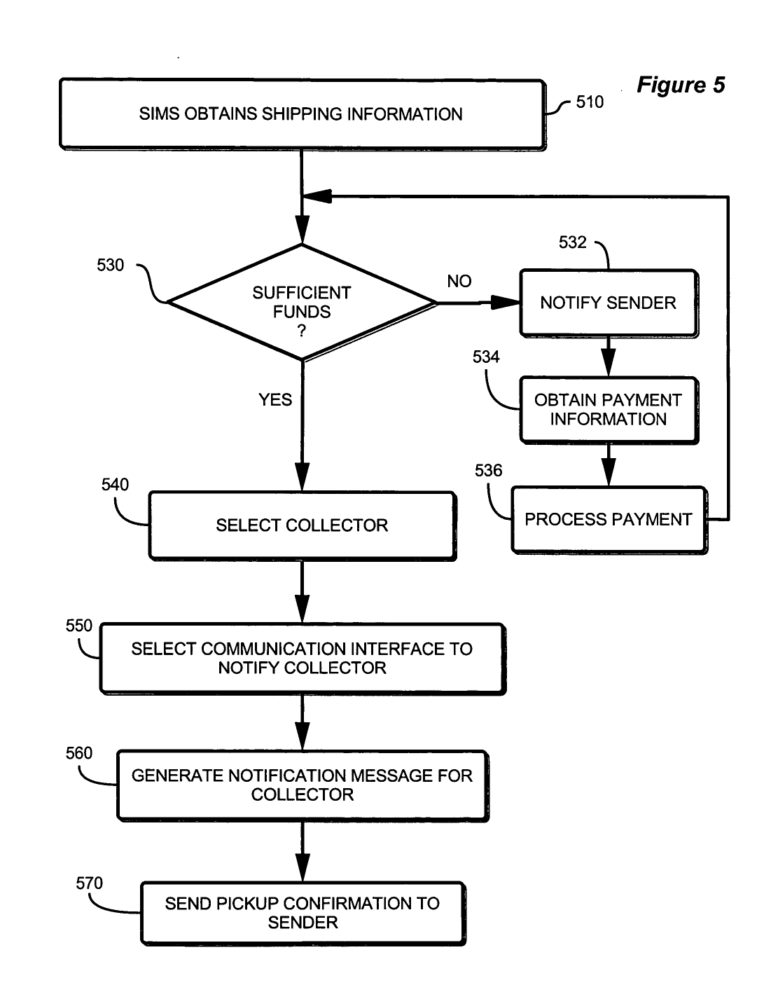

FIG. 5 is a flowchart diagram depicting a process for collecting and managing shipping information in accordance with an embodiment of the invention. At step 510, SIMS obtains shipping information (as described above). At step 520, SIMS checks whether funds are sufficient to cover the cost of pick-up. When sufficient funds are available, SIMS proceeds with selecting a collector at step 540.

SIMS may support several methods for covering the cost of pick-up. SIMS may process payment through a third party financial institution, such as a credit company or bank. SIMS may keep a running local account in which the customer may deposit funds and from which pick-up payments are drawn. SIMS may implement any available method for managing funds and/or transactions to move funds from one account to another. Alternatively, SIMS may run on a credit basis, meaning that customers may use services and pay later upon receiving the bill at a later time. SIMS may implement (or be interfaced with) account tools that enable SIMS to keep (and manage) credit payment accounts.

In some instances when the funds are insufficient, SIMS may notify the sender at step 532. For example, if a credit card has expired, SIMS may notify the sender about the expiration date, and may request new credit information. At step 534, SIMS obtains the payment information. SIMS may utilize the proxy application to display a message to the sender, generate a voice message to communicate through a telephone, text message to use through email or use any other means to notify the user and obtain payment information. At step 536, SIMS validates the payment information and processes the payment.

SIMS may be implemented with a set of intelligent tools that allow it to optimize pick-up selections based on information from multiple sources. For instance, SIMS may favor selecting a specific collector to serve a given customer based on the principle of building a customer service relationship. However, in instances when a second collector is available sooner than the usual collector, the system may opt for the collector who is available sooner in order to provide prompt service.

At step 550, SIMS selects one or more modes of communication to interface with a collector. For instance, SIMS may be configured to communicate directly with a collector or group thereof. In other instances, SIMS may use the system of a third party company specializing in pick-up services. The pick-up company may then convert or appropriately dispatch the messages to their collectors.

At step 560, SIMS may generate one or more messages to one or more collectors. For instance, SIMS may generate a voice message and a text message that may be both conveyed to the collector. SIMS may also simultaneously broadcast a message to a number of collectors if need be. SIMS may then obtain a reply from a collector to confirm receipt of the shipping information and confirmation of the pick-up schedule at step 570.

Embodiment of SIMS Functional Architecture

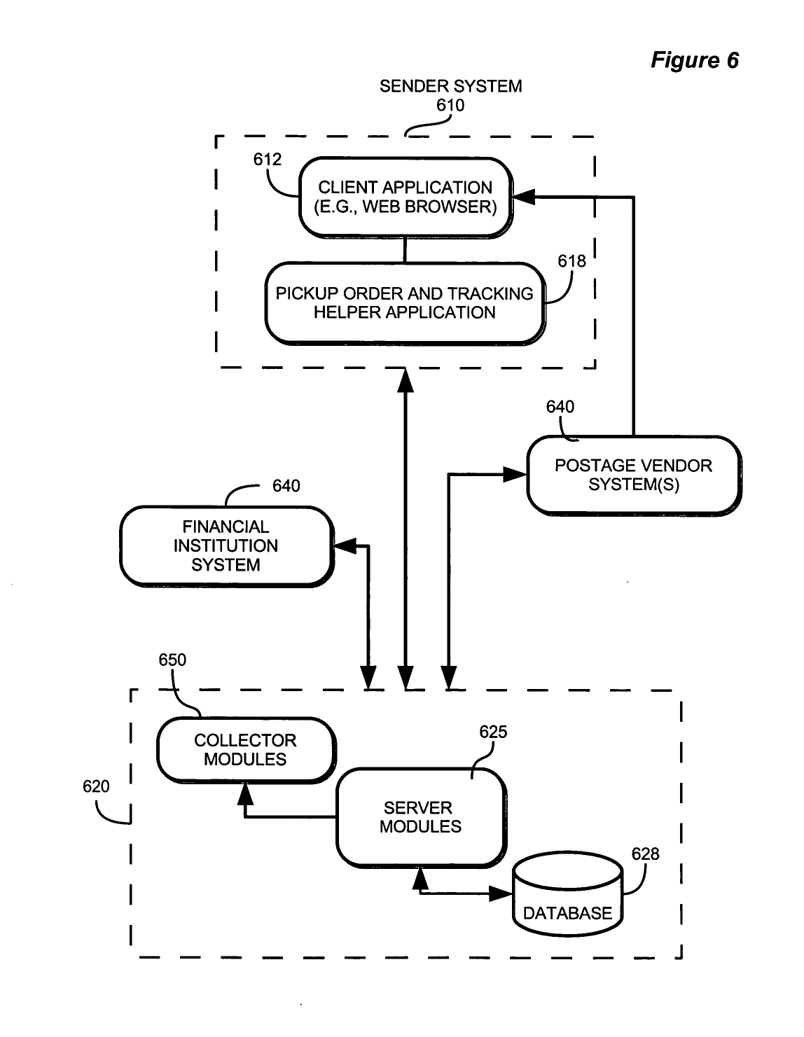

FIG. 6 is a block diagram of a distributed system architecture implemented in an embodiment of the invention. A system embodying the invention may comprise a server (e.g., block 620) configured to communicate with other parties' systems and client machines, to receive and interpret shipping information, to data-mine shipping information, to generate messages, and to securely store the information. For instance, a system embodying the invention may include multiple software modules for managing server connections and communications (e.g., block 625), software modules for integrating shipping information and communicating the shipping information and pick-up schedule with collectors (e.g., block 650), and a database module for storing information (e.g., block 628).

In an embodiment of the invention, the system's architecture may be web-based, where the primary system software resides in the server (e.g., block 620) located remotely from a customer's system/client (e.g., block 610), and the customer's system is connected to the server over the Internet.

The system may utilize network architecture to manage aspects of shipping transactions. An embodiment of the invention may be implemented on the Internet to allow customers access through the world wide web (WWW).

A customer's system (e.g., block 610) may include a client application (e.g., block 618) that executes on the client's machine to track and collect shipping information, and forward that information to the SIMS server.

The system may implement the client application as a standalone application, a helper application (e.g., a web browser plug-in) that executes along with a web application (e.g., block 612), a JAVA applet, or any other form of computer program for executing the client application to detect and/or collect shipping information and provide the information to the server. Moreover, the client application may be configured to receive data and instructions from a remote server (e.g., block 620) in order to communicate with the customer. For instance, when the customer is determined to be present at the client computer, the server may send a visual notification to the customer upon completing pick-up scheduling through the client application. The server may send a text message to the client application, and then the client application may generate a user interface widget, such as a pop-up window or a sound clip, to convey the transaction information to the customer.

The client application may function in the background and gather data pertinent to the shipping process. One of the methods employed in collecting the relevant data is by monitoring the print file that is used to print the shipping label. The print file to print the shipping label contains most of the necessary information pertaining to the shipping transaction. Such collected data is sent to the server, where the transaction module manages the collection and storage of such data in the server.

The customer may access the system on the web through the Internet with the use of any browser software such as Internet Explorers or Netscape Navigator™. Prior to using the system, the customer participates in a registration process (as described above). During registration, the customer provides personal information, such as his address including zip code and credit card or debit card information. Unless there is any change in the personal information in subsequent uses, the customer does not need to provide any more personal information to the system. There is a login procedure for a customer to get access to the system that is also set up during the registration process. The login procedure is similar to that used in other Internet-based systems that includes a customer-selected user identification and password.

The client application (e.g., in the customer's computer) may collect the data from the customer's computer in one of two ways. When the customer connects through the system's web site to any other web sites of other service providers such as shipping service providers, PC Postage service providers, shipping label printing service providers, or any other service providers that are necessary to facilitate the shipping process, the module in the customer's client application is automatically activated. Similarly, the client application may be automatically activated when a customer goes directly to a shipping provider's web site without going through the SIMS system. For example, web sites of shipping-related service providers may have been identified by the customer during the registration process or a list of common shipping service providers may be provided with the client application.

Similarly, couriers and shipping service providers may utilize a client application to communicate with the system. Couriers and shipping providers may go through a registration process in order to provide user information, however, a different set of information is collected from them and their access may also be controlled by a similar login process. In one embodiment, a postage vending system (e.g., block 640) may be enabled to communicate with the SIMS server or with the customer's client application. In another embodiment, a shipping provider's helper application may retrieve shipping information from the communication link between a customer's client system and the postage vending system and transmit it to the customer's client application and/or to the server.

The system is also enabled to communicate with financial institution systems to transfer funds. The system may implement any available protocol though which the system may carry out fund transfer transactions.

Example Embodiment of a SIMS Server

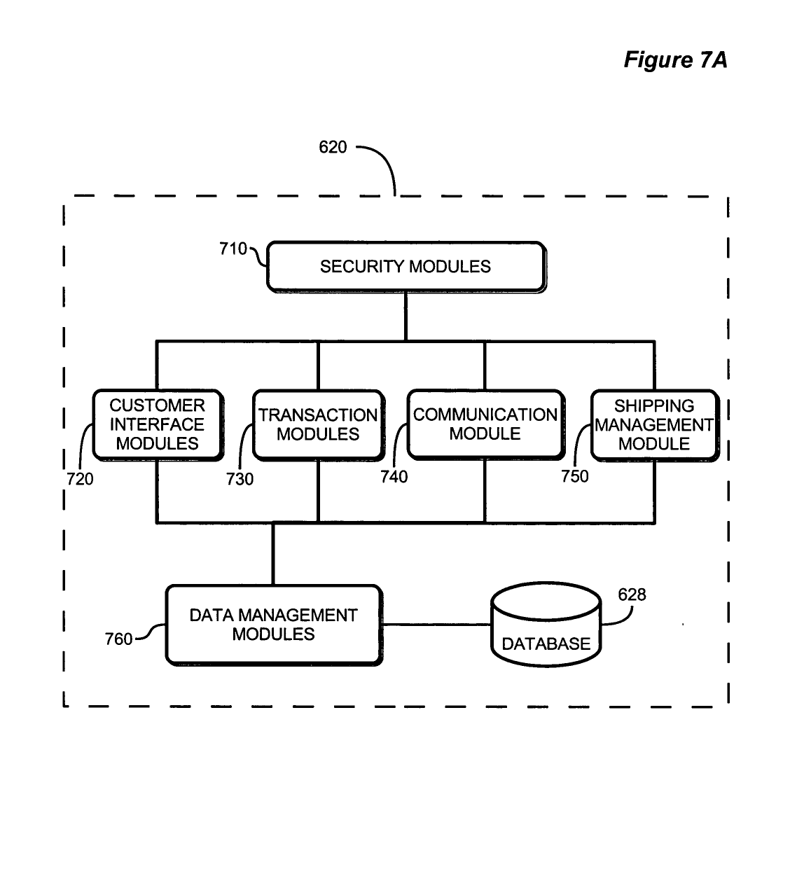

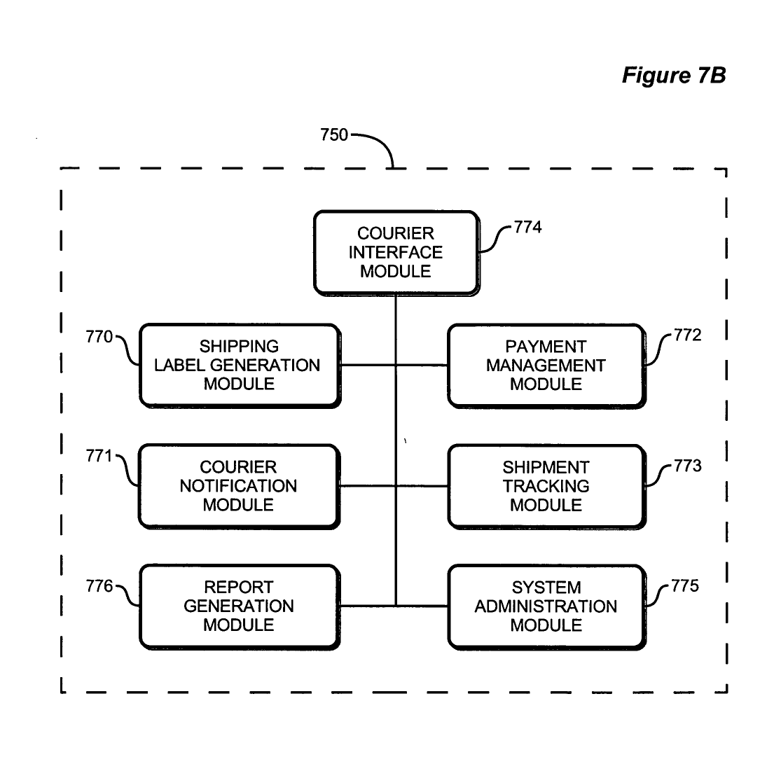

FIG. 7A is a block diagram of a server in an embodiment of the invention. The server side (block 620) may implement a set of server software components/modules. The system may include a database management module (block 760), a secure communication module (block 710), a customer interface module (block 720), a transaction module (block 730), and a shipping management module (block 750).

The database management module, block 760, in the server software provides the tools for storing the customer related information in the database (block 628), and interfacing with and retrieving the data from the database. The database management system implements data security features, such as data encryption and multi-level restricted user access such that there is no commingling of the data among the customers. Security measures may be built into the system to prevent unauthorized access to the database. Furthermore, security features may be incorporated in the database architecture, such as traceability of access, encryption of selected data, compartmentalization of the data among all the couriers and among all the shipping service providers, and state of the art firewalls including the ability to monitor any attempted intrusion.

The secure communication module (block 710) in the server software secures communication in and out of the system and within the system. All communication between the customer or anyone else from outside the system and the server may be made secure with the use of a secure socket layer (SSL) protocol that is commonly used in the industry. This module may also manage the encryption and decryption functions that are used in encrypting certain data before storage in the database. In one embodiment, certain confidential data, such as credit card or debit card information or social security numbers, is not stored in the database in clear form. Such data may be stored in encrypted form and decrypted internally for any usage. In addition, this confidential data may be kept in temporary memory that will have no permanent record in the system.

The customer interface module (block 720) in the server manages the information that is transferred between the customer and the server. The customer registration and subsequent login processes may be managed by this module. This module functions in conjunction with the secure communication module to ensure that inbound and outbound communications are totally secure.

The customer may be given various choices in selecting the services provided by the system. In the registration process, the customer may identify the specific type of pick-up service the customer needs and also identify shipping related service providers, such as the USPS, Stamps.com, eBay™ or any other service providers. This module provides interfaces to the customer for making such service choices and maintains those choices until the customer makes further changes.

The transaction module (block 730) in the server manages the transaction that is being performed by the customer. The transaction module may collect relevant information, such as the time and date of the transaction, the shipping service provider the customer has selected, the mode of shipment, the service used by the customer to print the shipping label, the address to which the shipment is sent to, the cost of shipment, the mode of payment, the tracking number of the shipment and any other pertinent information. The transaction module may interface with an active-x control module or a thin client module that has been automatically downloaded to the customer's computer at the time of registration by the customer.

Embodiments of the invention may be configured such that, by default, the pick-up service is automatically triggered when the customer prints a shipping label. As an adjunct to this default behavior, one or more embodiments may provide a web service page or other interface mechanism through which the customer can suspend the pick-up scheduling service. For example, in one embodiment, when pick-up scheduling is suspended, no pick-up services are scheduled for the customer until and unless the customer affirmatively elects to resume the pick-up scheduling service, e.g., through a web service page having a user input mechanism for requesting renewal/resumption of the pick-up scheduling service. The transaction module 730 may monitor whether the customer has specifically and affirmatively instructed not to have any further pick-up service until a request for pick-up service renewal is made.

The communication module (block 740) may provide tools that allow the system to communicate with multiple devices using multiple message formats (e.g., voice mail, text message, etc.) that are streamed through multiple communication means. For example, the system may automatically generate a voice message that is communicated to a courier by telephone, in which case, the system utilizes the tools of communication module 740 to communicate with the courier. The system may also offer the courier the option of keying in responses (e.g., from a menu of selections) in order to obtain immediate confirmation of receipt of message and agreement of a pickup schedule.

FIG. 7B is a block diagram that represent further modules contained in the shipping management module in an embodiment of the invention. The shipping management module (block 750) may include, for example, a courier notification module (block 771), a shipping label generation module (block 770), a payment management module (block 772), a report generation module (block 776), a courier interface module (block 774), a shipment tracking module (block 773), and a system administration module (block 775).

The courier notification module 771 in the server may include tools for notifying a local courier or courier service dispatcher that a customer printed a shipping label. In one embodiment of the invention, a courier may be assigned to service a given customer. The notification may be carried out using any currently available means for communicating. For example, notification module 771 may utilize an email address provided by the courier (and associated to the customer's zip code) or by a digital instant messaging address of the courier.

In the registration process previously described, the customer may select a standard time at which a courier normally picks up shipments after a pick-up instruction is issued. In one embodiment of the invention, pick-ups are limited to one designated time per day, unless there is a special request. Thus, couriers can develop a consistent daily route, visiting or bypassing a given customer's location based on whether a pick-up instruction was logged prior to the time the courier reached the customer's location. Any shipment generated after the designated pick-up time on any day may be picked up on the next day at the designated pick-up time.

In addition to an email or other message notification to the courier, a web page available only to the courier may be updated to include the new notification of the pickup with the detailed information of the shipment including the time and date of the generation of the shipping label, customer information, the shipping service provider, mode of shipment, shipment destination address, cost of shipment and any other pertinent information. The courier or a courier dispatcher may also have an electronic list of pick-up instructions for a current day to which new pick-up messages are appended as they arrive (e.g., as email, instant message or other electronic communication).

The courier notification module 771 may select a specific courier for a customer's pick-up from a group of couriers servicing the area covered by the zip code of a customer. The courier assignment to a particular customer may be based, for example, on minimizing the travel time for a courier from its base and the availability of the courier for pickup at the customer's selected time. In one embodiment, the same courier would be assigned to provide pick-up service for the same customer all the time, unless changes would result in an increase in service efficiency.

The shipping label generation module (block 770) in the server software may include tools for generating shipping labels for certain types of shipments, including custom shipment modes that may not otherwise be provided by shipping service providers. The customer inputs all the necessary shipping related information, such as address to which the shipment is being sent, the size and weight of the shipment, and the mode of shipment, through a user interface (e.g., a web page). One or more embodiments of the invention may be configured to obtain destination addresses from an address book or a contact related software tool. In addition, the system may obtain the weight directly from a scale connected to a computer.

The shipping label generation interface is made simple for a customer to use the system in a convenient and efficient manner. The shipping label generation module may also compute the cost of the shipment from a rate table stored in the server database. Such cost may or may not be clearly marked on the shipping label. The printing of the shipping label generated by this module initiates the courier notification process.

The payment management module (block 772) in the server software may include tools for the management of payments by the customer for the shipping transactions that involve generation of the shipping labels by the system and for all the pickup services provided to the customer. When the customer prints shipping labels using web sites of other vendors such as the USPS, Stamps.com and eBay,™ the cost of shipment is directly paid to them through the payment methods such vendors provide, whereas payment for pick-up service is managed by this module. Module 772 may provide payment options to the customer through various credit cards and debit cards as well as ACH.

At the time of registration, the customer may elect the form of payment to be applied for pick-up services, and may provide the necessary credit card or debit card billing information. The customer is not required to provide new billing information for subsequent services unless there are changes to the billing information.

Customer billing information may be securely stored in the database. Module 772 retrieves the necessary data from the database for facilitating payment when services are rendered to the customer. Module 772 generates and manages the record of customer payments and interfaces with the report generation module 776 in creating and presenting various forms of customer usage reports.

The report generation module (block 776) in the server software may provide tools for generating various types of reports that are available to the customer. Those reports may include, for example, a chronological activities report for a customer containing time and date of transactions, identity of the shipping service provider, address to which the shipment is sent, cost of shipment, service provider through which the cost of shipment is paid, mode of shipment, cost of pickup service, cost of insurance, if any, and any other shipping related information. Module 776 may also be configured to generate reports containing different combinations of information. There may also be provisions for the selection of reports tailored to a specific customer. This module also creates reports for each courier showing its activities that include all pertinent shipping and pickup related information. The courier can select different types of reports tailored to its needs.

The courier interface module (block 774) in the server software may include tools for managing the interface between the server and the courier. Similar to a customer registering with the system, a courier may register with the system, giving pertinent information applicable to providing the pick-up service and the details of the service area.

Module 774 manages changes to the courier service areas and any other service related information. This module, in conjunction with transaction module 730, courier notification module 771 and report generation module 776, updates the courier activities in the database. The accounting information related to the courier activities, including payments made to the courier, is managed by this module.

The shipment tracking module (block 773) in the server software may include tools for managing the shipment tracking function. This module interfaces with the tracking services provided by the various shipping service providers. The customer can input the tracking number of the shipment in a user interface (e.g., web page) input element for transmission to the SIMS server. Module 773 monitors input tracking numbers and, by identifying the shipping service the customer has selected for this particular shipment, module 773 interfaces with the appropriate tracking facility provided by the shipping service provider to display the status of the shipment to the customer.

The system administration module (block 775) in the server software may include tools for managing administrative functions of the system. Through this module, system administrators may obtain access to the entire system, and are able to monitor the performance of the various modules within the system. Major functions, such as monitoring the security of the system, operational efficiency, use of system resources; generation of operational reports, system or module failure reports, customer statistics, system use statistics, financial records, courier service records; and other related functions are performed by this module.

Compared to the prior art, embodiments of the invention provide a novel approach to providing automatically scheduled pick-up service to customers, e.g., triggered as a result of a postage purchase or label printing operation. Embodiments of the invention enable customers to print shipping labels, and automatically notify a courier to pick up the shipment. Moreover, embodiments of the invention facilitate payment for the pick-up service, including funds transfer transactions using one or more interfaces with financial institutions. One or more embodiments enable the customer to access a consolidated and comprehensive up-to-date shipping report containing relevant shipping transaction information.

Thus, a method and apparatus for facilitating shipping of mail and packages have been described. Particular embodiments described herein are illustrative only and should not limit the present invention thereby. The invention is defined by the claims and their full scope of equivalents.

1. A method for facilitating shipping, comprising:
in a computer system, automatically detecting that a user has obtained a shipping label for a shipment;
obtaining shipping information associated with said shipping label; and
based on said shipping information, automatically scheduling a pick-up service to obtain said shipment from said user.

2. The method of claim 1, wherein said shipping information is obtained transparently with respect to said user.

3. The method of claim 1, wherein said shipping information is obtained from a postage purchasing process.

4. The method of claim 1, wherein scheduling said pick-up service comprises:
electronically communicating said shipping information to a pick-up service provider.

5. The method of claim 4, wherein scheduling said pick-up service further comprises:
accessing pre-existing account information associated with said user.

6. The method of claim 5, wherein scheduling said pick-up service further comprises:
verifying a payment for said pick-up service based on billing information in said pre-existing account information.

7. The method of claim 6, wherein scheduling said pick-up service further comprises:
detecting non-acceptance of said payment; and
presenting a user interface element to said user for obtaining alternate payment information.

8. The method of claim 5, wherein scheduling said pick-up service further comprises:
obtaining a user address from said pre-existing account information; and
communicating said user address to said pick-up service provider.

9. The method of claim 8, wherein scheduling said pick-up service further comprises:
selecting a pick-up service provider.

10. The method of claim 9, wherein selecting said pick-up service provider comprises:
accessing one or more user preferences in said pre-existing account information.

11. The method of claim 9, wherein selecting said pick-up service provider comprises:
identifying a local provider from said user address.

12. The method of claim 9, wherein selecting said pick-up service provider comprises:
evaluating one or more handling parameters from said shipping information; and
matching said handling parameters with one or more handling capabilities of said pick-up service provider.

13. The method of claim 9, wherein selecting said pick-up service provider comprises:
comparing one or more pick-up rates of a plurality of pick-up service providers.

14. The method of claim 5, further comprising:
obtaining said pre-existing information from a user during a service registration process.

15. The method of claim 14, further comprising:
loading computer program code in said computer system during said service registration process, wherein said computer program code is configured to monitor a postage purchasing process and to communicate said shipping information to an information server.

16. The method of claim 4, further comprising:
determining a communication format associated with said pick-up service provider; and
transmitting pick-up instructions to said pick-up service provider in said communication format.

17. The method of claim 4, further comprising:
determining whether said user has authorized automatic pick-up service scheduling.

18. The method of claim 17, further comprising:
determining that automatic pick-up service scheduling is not authorized;
providing a user interface element through which said user may provide an authorization.

19. The method of claim 18, wherein said authorization is a continuous authorization.

20. The method of claim 18, wherein said authorization is a transactional authorization.

21. The method of claim 4, further comprising:
recording said shipping information as a transaction in a database.

22. The method of claim 21, further comprising:
providing said user with access to information in said database that is specific to said user.

23. The method of claim 21, further comprising:
mining information from said database across a plurality of users to predict future resource needs for a shipping service provider.

24. The method of claim 21, further comprising:
mining information from said database to evaluate past activity of a shipping service provider.

25. The method of claim 21, wherein said pick-up service provider transfers said shipment to a shipping service provider, said method further comprising:
communicating said shipping information and pick-up service information to said shipping service provider prior to said shipment being transferred to said shipping service provider.

26. The method of claim 25, further comprising:
identifying said shipping service provider from said shipping information.

27. The method of claim 4, wherein said shipping information is communicated to said pick-up service provider by electronic mail.

28. The method of claim 4, wherein said shipping information is communicated to said pick-up service provider using instant messaging services.

29. The method of claim 4, wherein said shipping information is communicated to said pick-up service provider by voice communications.

30. The method of claim 4, wherein said shipping information is communicated to a dispatcher for said pick-up service provider.

31. The method of claim 4, wherein said shipping information is communicated directly to a driver for said pick-up service provider.

32. The method of claim 1, further comprising:
transmitting a confirmation message to said user comprising pick-up schedule information.

33. The method of claim 1, further comprising:
transmitting a notification message to a shipment destination based on said shipping information.

34. An apparatus comprising:
user computer program code executing in a user computer;
server computer program code executing in a server computer;
wherein said user computer program code is configured to:
automatically detect that a user has obtained a shipping label for a shipment;
obtain shipping information associated with said shipping label; and
transmit said shipping information to said server computer;
wherein said server computer program code is configured to automatically schedule a pick-up service to obtain said shipment from said user.

35. The apparatus of claim 34, wherein said server computer comprises:
a database tracking a plurality of shipping transactions of a plurality of users.

36. The apparatus of claim 34, wherein said server computer comprises:
a database maintaining a plurality of user accounts, wherein said plurality of user accounts each comprise billing information and address information of a respective user.

37. The apparatus of claim 34, wherein said user computer program code is further configured to obtain said shipping information from a postage purchase transaction process.

38. The apparatus of claim 34, further comprising:
a plurality of pick-up service providers in communication with said server computer;
wherein said server computer program code is configured to select one of said plurality of pick-up service providers, and communicate a pick-up service instruction to said pick-up service provider based on said shipping information.

39. The apparatus of claim 34, wherein said server computer program code is further configured to provide advance shipping information to a shipping service provider prior to said shipment being deposited with said shipping service provider by a pick-up service provider.

40. The apparatus of claim 34, wherein said server computer program code is further configured to verify a user payment with a financial entity prior to scheduling said pick-up service.
